(19) United States
(12) Patent Application Publication
(10) Pub. No.: US 2021/0089362 A1
(43) Pub. Date: Mar. 25, 2021

(54) VIRTUAL RESOURCE MANAGEMENT DEVICE, VIRTUAL RESOURCE ALLOCATION METHOD, AND VIRTUAL RESOURCE ALLOCATION PROGRAM

(71) Applicant: Nippon Telegraph and Telephone Corporation, Tokyo (JP)

(72) Inventors: Eriko Iwasa, Musashino-shi, Tokyo (JP); Makoto Hamada, Musashino-shi, Tokyo (JP)

(21) Appl. No.: 16/970,039

(22) PCT Filed: Feb. 14, 2019
(86) PCT No.: PCT/JP2019/005428

§ 371 Date: Aug. 14, 2020

(30) Foreign Application Priority Data
Feb. 19, 2018 (JP) 2018-026851

(51) Int. Cl. G06F 9/50; G06F 9/455

(52) U.S. Cl. CPC G06F 9/5077; G06F 9/45533

(57) ABSTRACT

[Problem] To increase utilization efficiency of virtual machine resources while operating and managing virtual machines using the IaaS base.

[Solution] A virtual resource allocation program causes a computer to perform allocating an activation CPU 51 to a virtual machine implemented on a server and activating the virtual machine, selecting a service CPU 52 satisfying a user requirement after the virtual machine is activated, and pinning the service CPU 52 satisfying the user requirement to every virtual CPU of the virtual machine.

### TECHNICAL FIELD

The present disclosure relates to a virtual resource management apparatus, a virtual resource allocation method, and a virtual resource allocation program in which, while utilizing a commercially-available Infrastructure as a Service (IaaS) base for generating a complicated setting file of a virtual machine, a setting item restricted on the commercially-available IaaS base, for example, the setting file of the virtual machine in which virtual Central Processing Units (CPUs) and physical CPUs are pinned at N:1, is rewritten to a desired condition, and then setting is applied by performing reactivation.

### BACKGROUND ART

The recent trend has been to adopt Network Functions Virtualization (NFV) to which a virtualization technology is applied. Network virtualization converts a network function that has been realized with dedicated hardware into a software-based configuration that can operate on a general-purpose server. It is expected that applying the virtualization technology to a carrier network enables both scalability and reliability, as well as provision of a rapid service, flexible resource allocation in accordance with the demand of each service, and realization of service deployment without being limited to the lifespan of hardware.

Considering application of the network virtualization technology to a network device with high performance requirements, it is necessary to pursue real-time performance and to suppress performance fluctuations. In virtualization, one method for satisfying such performance requirements is CPU pinning, which associates a virtual CPU with a physical CPU (CPU core). With CPU pinning, a virtual CPU of a virtual machine can exclusively occupy a physical CPU core to improve real-time performance, and thus can suppress performance fluctuation.

In OpenStack, it is possible to designate whether or not CPU pinning is performed for each virtual machine. In OpenStack, a CPU pinning policy can be described in flavor extra specs in the format of hw_cpu_policy=dedicated (Non Patent Literature 1). It is possible to realize CPU pinning by using flavors in which CPU pinning policies are set. The flavor is designated for each virtual machine.

In a Kernel-based Virtual Machine (KVM), it is possible to designate detailed items such as designation of whether or not CPU pinning is performed for each virtual CPU, and multiplicity in CPU pinning. In the KVM, a physical CPU to be allocated with a virtual CPU may be designated in a setting item of vcpupin in a setting file (XML file) of a virtual machine (Non Patent Literature 2).

In the contents of a setting file required when a virtual machine is generated, setting items are various and very complicated. However, in an IaaS base such as OpenStack, it is possible to automatically generate the XML file immediately before activation, by inputting basic information on a CPU, a memory, or the like to be allocated using a graphical user interface.

### CITATION LIST

### Non Patent Literature

Non Patent Literature 1: “Flavors”, [online], OpenStack Docs, [searched on Jan. 22, 2018], Internet <URL: https://docs.openstack.org/nova/pike/admin/flavors.html>
Non Patent Literature 2: “libvirt”, [online], Domain XML format, [searched on Jan. 22, 2018], Internet <URL: https://libvirt.org/formatdomain.html#elementsCPUTuning/>

### SUMMARY OF THE INVENTION

### Technical Problem

The setting items available on the IaaS base may be coarse in granularity, and it may be difficult to make settings taking advantages of virtualization.

For example, communication software may have an application in which a process having a high performance requirement and a process having a low performance requirement may be mixed. The process having a high performance requirement is, for example, a process for performing data plane processing. The process having a low performance requirement is, for example, a process for performing maintenance-related processing.

If CPU pinning is selected for each virtual machine in consideration of a process having a high performance requirement by using a commercially-available IaaS base such as OpenStack, a CPU core is exclusively allocated to even a process having a low performance requirement. Thus, resource utilization efficiency does not increase in CPU pinning on OpenStack.

If a plurality of virtual machines are mounted and operated on a virtualization platform, a load at the virtual machines activation alters according to the changes of resource use state, the number of virtual machines that simultaneously activate, or the like. However, such an influence at time of activation is not considered in the commercially-available IaaS base.

On the other hand, operating and managing a system including a plurality of virtual machines without using the IaaS base requires all complicated definition files to be manually set, and this is impractical.

An object of the present disclosure is to increase utilization efficiency of virtual machine resources while operating and managing virtual machines using the IaaS base.

### Means for Solving the Problem

To solve the above problem, according to an embodiment of the invention described in claim 1, a virtual resource allocation program causes a computer to perform allocating a first physical CPU to a virtual CPU of a virtual machine implemented on a server, by an IaaS base, and activating the virtual machine, selecting a second physical CPU satisfying a user requirement after the virtual machine is activated, and pinning the second physical CPU to every virtual CPU of the virtual machine.

In this manner, it is possible to increase utilization efficiency of virtual machine resources while operating and managing a virtual machine using an IaaS base.

According to an embodiment of the invention described in claim 2, the virtual resource allocation program according to claim 1 causes the computer to further perform selecting the first physical CPU to be allocated in order to activate the virtual machine, in accordance with use states of a plurality of physical CPUs in the server.

In this manner, it is possible to flexibly select activation resources in accordance with a load or the number of machines that simultaneously activate, and thus to stably activate the virtual machines.

According to an embodiment of the invention described in claim 3, the virtual resource allocation program according to claim 2 causes the computer to further perform setting the physical CPU that does not perform a service and the physical CPU that simultaneously performs a plurality of services, as a selection target of the first physical CPU, and excluding the exclusive physical CPU that performs a specific service from the selection target of the first physical CPU.

In this manner, it is possible to stably activate the virtual machine without affecting the specific service.

According to an embodiment of the invention described in claim 4, the virtual resource allocation program according to claim 1 causes the computer to further perform extracting physical CPUs which are not exclusive and are capable of performing a plurality of services and for selecting the second physical CPU from the extracted physical CPUs which are not exclusive.

In this manner, it is possible to increase the utilization efficiency of virtual machine resources.

According to an embodiment of the invention described in claim 5, a virtual resource allocation method includes allocating a first physical CPU to a virtual CPU of a virtual machine implemented on a server, by an IaaS base, and activating the virtual machine, selecting a second physical CPU satisfying a user requirement after the virtual machine is activated, and pinning the second physical CPU to every virtual CPU of the virtual machine and reactivating the virtual machine.

In this manner, it is possible to increase utilization efficiency of virtual machine resources while operating and managing a virtual machine using an IaaS base.

According to an embodiment of the invention described in claim 6, a virtual resource management apparatus includes a resource selection unit configured to select a first physical CPU to be allocated as a virtual CPU of a virtual machine by an IaaS base, for an initial activation of the virtual machine implemented on a server, and to select a second physical CPU satisfying a user requirement after the virtual machine is activated, and a virtual machine setting file operation unit configured to pin the second physical CPU to every virtual CPU of the virtual machine.

In this manner, it is possible to increase utilization efficiency of virtual machine resources while operating and managing a virtual machine using an IaaS base.

According to an embodiment of the invention described in claim 7, the virtual resource management apparatus according to claim 6 further includes a resource extraction unit configured to extract a physical CPU which is capable of performing a plurality of services and is not exclusive, as a candidate for the first physical CPU.

In this manner, it is possible to flexibly select activation resources in accordance with a load or the number of machines that simultaneously activate, and thus to stably activate the virtual machines.

According to an embodiment of the invention described in claim 8, in the virtual resource management apparatus according to claim 7, the resource extraction unit excludes an exclusive physical CPU that performs a specific service from a selection target of the first physical CPU.

In this manner, it is possible to activate the virtual machine without affecting the specific service.

### Effects of the Invention

According to the present disclosure, it is possible to increase utilization efficiency of virtual machine resources while operating and managing virtual machines using the IaaS base.

### BRIEF DESCRIPTION OF DRAWINGS

FIG. 1 is a diagram illustrating a virtual resource management system according to an embodiment of the present invention.

FIG. 2 is a flowchart illustrating processing by a virtual resource management apparatus and an IaaS base apparatus.

FIG. 3 is a flowchart illustrating first processing performed by the IaaS base apparatus.

FIG. 4 is a flowchart illustrating second processing performed by the IaaS base apparatus.

FIG. 5 is a diagram illustrating a resource management table.

FIG. 6 is a diagram illustrating a resource selection table for selecting an activation CPU.

FIG. 7 is a flowchart illustrating processing of selecting an activation CPU resource by the virtual resource management apparatus.

FIG. 8 is a diagram illustrating a resource selection table.

FIG. 9 is a flowchart illustrating processing of extracting an allocable resource.

FIG. 10 is a diagram illustrating a virtual machine setting file created by an IaaS base tool.

FIG. 11 is a diagram illustrating the virtual machine setting file modified by the virtual resource management apparatus.

### DESCRIPTION OF EMBODIMENTS

In order to generate a virtual machine, a setting file in which resource allocation settings and the like are described is required, but the setting items are various and very complicated. In an IaaS base such as OpenStack, a user inputs basic information on a CPU, a memory, or the like to be allocated to the virtual machine, by using a graphical user interface. This enables the setting file to be generated immediately before activating a virtual machine.

There are also restrictions on items allowed to be set from the IaaS base such as OpenStack. For example, there is a method referred to as CPU Pinning in which a virtual CPU is fixedly allocated to a physical CPU for an application having high performance requirements. However, OpenStack allows only one-to-one pinning between virtual CPUs and physical CPUs. The CPU pinning policy needs to be set for each virtual machine.

According to an embodiment of the present invention, an instance is generated via the commercially-available IaaS base, and then, for an item restricted in setting from the IaaS base, a setting file of the virtual machine is rewritten to a desired condition (for example, the virtual CPUs and the physical CPU are pinned in the ratio of N to 1), and then reactivation is performed, by which the setting is applied.

Hereinafter, embodiments of the invention will be described in detail with reference to the drawings.

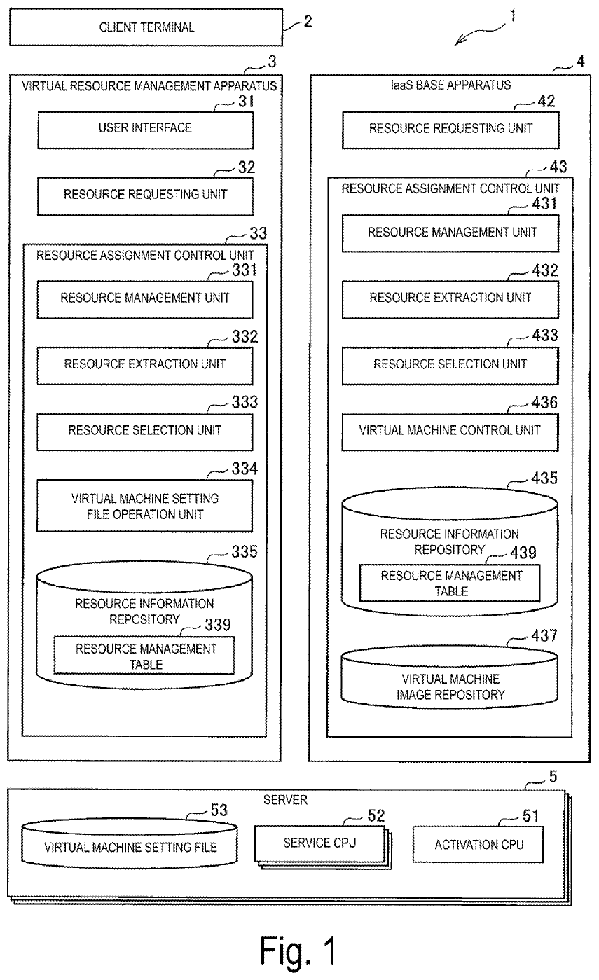

FIG. 1 is a diagram illustrating a virtual resource management system 1 according to an embodiment of the present invention.

The virtual resource management system 1 is configured to include a client terminal 2, a virtual resource management apparatus 3 controlled by the client terminal 2, and an IaaS base apparatus 4. The virtual resource management system 1 is communicably connected to a plurality of servers 5 functioning as physical resources.

The plurality of servers 5 are physical resources for implementing a virtual machine, and include a plurality of physical CPU cores that operate independently from each other. Each server 5 is configured to include one activation CPU 51, a plurality of service CPUs 52, and a virtual machine setting file 53 storing setting information of the virtual machine. The activation CPU 51 and the plurality of service CPUs 52 are physical CPU resources allocated to the virtual CPU of the virtual machine. The same CPU may be used as both the activation CPU 51 and the plurality of service CPUs 52 depending on the situation. The physical CPU core used as the activation CPU 51 may be used as the service CPU 52, and the present disclosure is not limited thereto.

The virtual machine setting file 53 is used for holding information indicating the setting state of each constructed virtual machine. If the IaaS base apparatus 4 or the virtual resource management apparatus 3 allocates a physical CPU resource to each virtual machine, the result is applied to the contents of the virtual machine setting file 53.

The client terminal 2 includes a display (not illustrated) functioning as a display unit, and a mouse and a keyboard (not illustrated) functioning as an input unit.

The virtual resource management apparatus 3 is configured to include a user interface 31, a resource requesting unit 32, and a resource assignment control unit 33. The virtual resource management apparatus 3 is a computer configured to include a CPU, a RAM and a ROM (not illustrated), and executes a virtual resource allocation program. This enables the virtual resource management apparatus 3 to perform CPU pinning with finer granularity than CPU pinning by the IaaS base apparatus 4.

The user interface 31 displays control information of the virtual resource management apparatus 3 on the display (not illustrated) of the client terminal 2 and is configured to input various kinds of information with the mouse or the keyboard (not illustrated).

The resource requesting unit 32 requests the physical CPU resource managed by the IaaS base apparatus 4, as the activation CPU 51, and requests the physical CPU resource managed by the virtual resource management apparatus 3, as the service CPU 52.

The resource assignment control unit 33 assigns the physical CPU resource managed by the IaaS base apparatus 4, as the activation CPU 51, and further assigns the physical CPU resource managed by the virtual resource management apparatus 3, as the service CPU 52. The resource assignment control unit 33 includes a resource management unit 331, a resource extraction unit 332, a resource selection unit 333, a virtual machine setting file operation unit 334, and a resource information repository 335. A resource management table 339 is a table managed by the resource information repository 335.

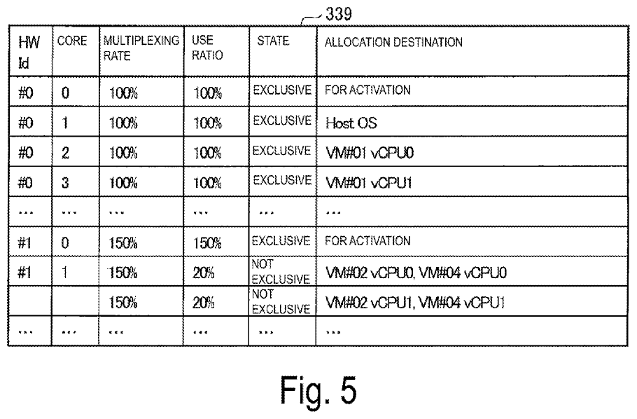

The resource management unit 331 manages each available physical resource with the resource management table 339. The resource management unit 331 also collects information on the physical CPU resources managed by the IaaS base apparatus 4, and registers and manages the information in the resource information repository 335. The configuration of the resource management table 339 will be described later with reference to FIG. 5.

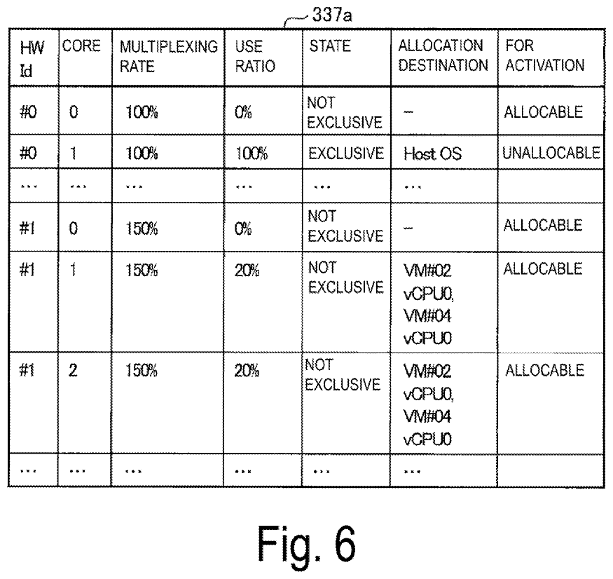

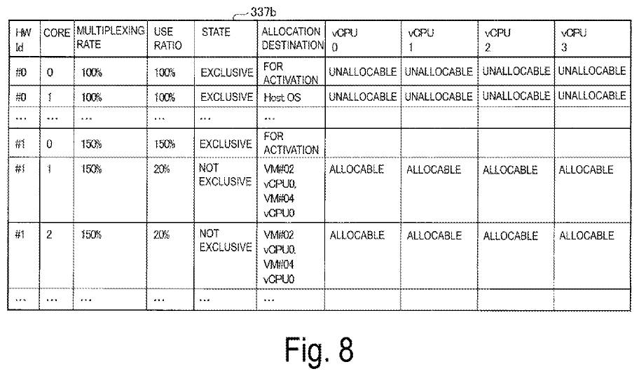

The resource extraction unit 332 extracts physical CPU resources as candidates from the resource management table 339 of the resource information repository 335, and generates a resource selection table 337a illustrated in FIG. 6 and a resource selection table 337b illustrated in FIG. 8. The resource selection unit 333 makes a selection from the physical CPU resources extracted by the resource extraction unit 332. The configuration of the resource selection table 337 will be described later with reference to FIG. 6 and FIG. 8.
The virtual machine setting file operation unit 334 operates the virtual machine setting file 53 generated by the IaaS base apparatus 4.
The resource information repository 335 is a database for centrally managing a state of using a resource of the server 5, which functions as the physical resource.

The IaaS base apparatus 4 is configured to include a resource requesting unit 42 and a resource assignment control unit 43. The IaaS base apparatus 4 is a commercially-available IaaS base such as OpenStack and has a function of allocating physical resources to a virtual machine, such as a function of pinning a virtual CPU constituting a virtual machine to a physical CPU.

The resource requesting unit 42 requests physical CPU resources of a plurality of servers 5.

The resource assignment control unit 43 causes the plurality of servers 5 to assign physical CPU resources. The resource assignment control unit 43 is configured to include a resource management unit 431, a resource extraction unit 432, a resource selection unit 433, a virtual machine control unit 436, a resource information repository 435, and a virtual machine image repository 437. A resource management table 439 is a table managed by the resource information repository 335.

The resource management unit 431 manages the usage state of each physical CPU resource with the resource management table 439. The resource management unit 431 collects information of physical CPU resources from the plurality of servers 5 and registers and manages the information in the resource information repository 435.

The resource extraction unit 432 extracts physical CPU resources as candidates from the resource information repository 435. The resource selection unit 433 makes a selection from the physical CPU resources extracted by the resource extraction unit 432. The virtual machine control unit 436 embodies a virtual machine on the server 5 based on the virtual machine image repository 437, and performs control such as activation and termination of the virtual machine. The virtual machine image repository 437 is a database for centrally managing each virtual machine image.

A resource management method on the IaaS base side is not limited to the above description, and the resource may be managed by another method.

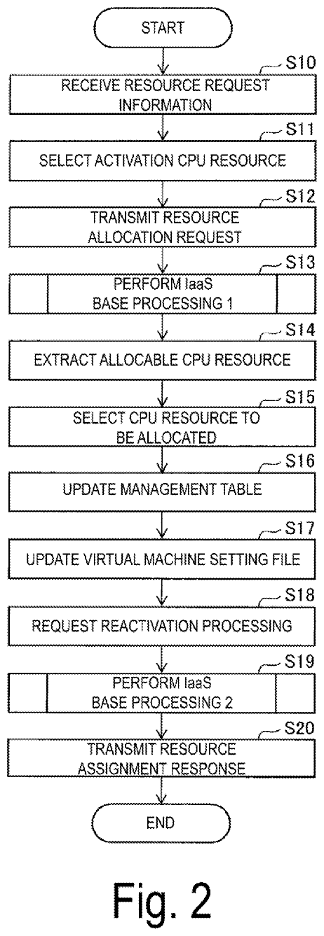

FIG. 2 is a flowchart illustrating an outline of processing by the virtual resource management apparatus 3 and the IaaS base apparatus 4.

The virtual resource management apparatus 3 displays an operation screen (not illustrated) on the display of the client terminal 2 through the user interface 31, and receives information regarding an assignment request of a virtual resource from a user (Step S10).

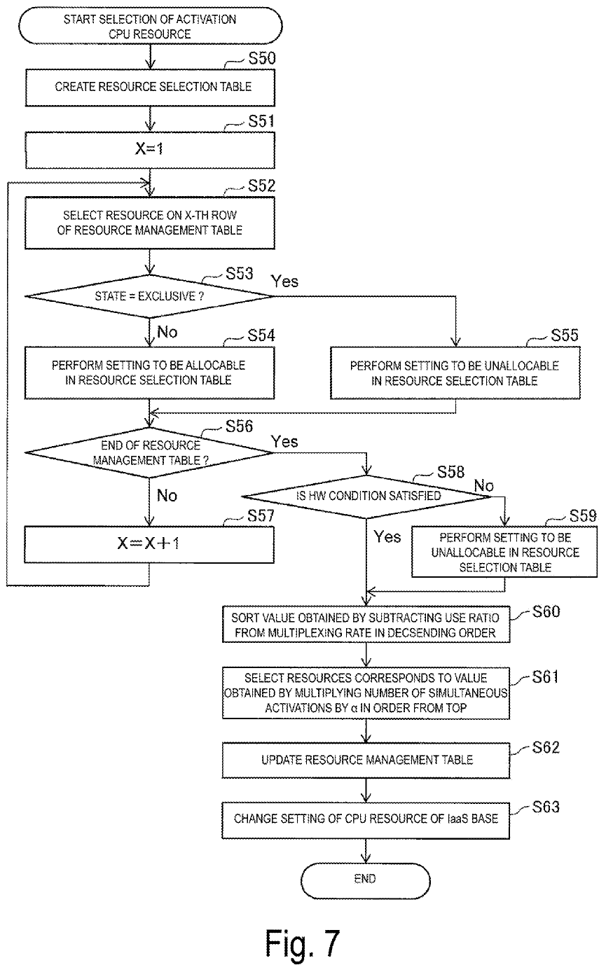

The virtual resource management apparatus 3 causes the resource selection unit 333 to select a physical CPU resource (first physical CPU) used for activating the virtual machine (Step S11). Specifically, the resource selection unit 333 selects an activation CPU 51 from any server 5, as the physical CPU resource used for activating the virtual machine. The processing of Step S11 will be described in detail with reference to FIG. 7.

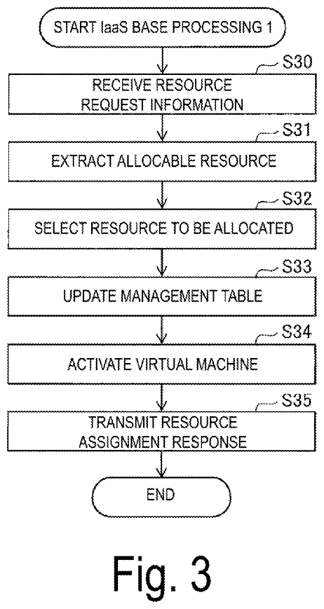

The resource requesting unit 32 requests the IaaS base apparatus 4 to allocate the selected resource (Step S12). Then, the IaaS base apparatus 4 performs first processing of assigning resources and activating the virtual machine (Step S13). The first processing will be described later with reference to FIG. 3. The processing of Steps S11 to S13 corresponds to a procedure of allocating a first physical CPU to a virtual CPU of a virtual machine implemented on the server 5 and activating the virtual machine.

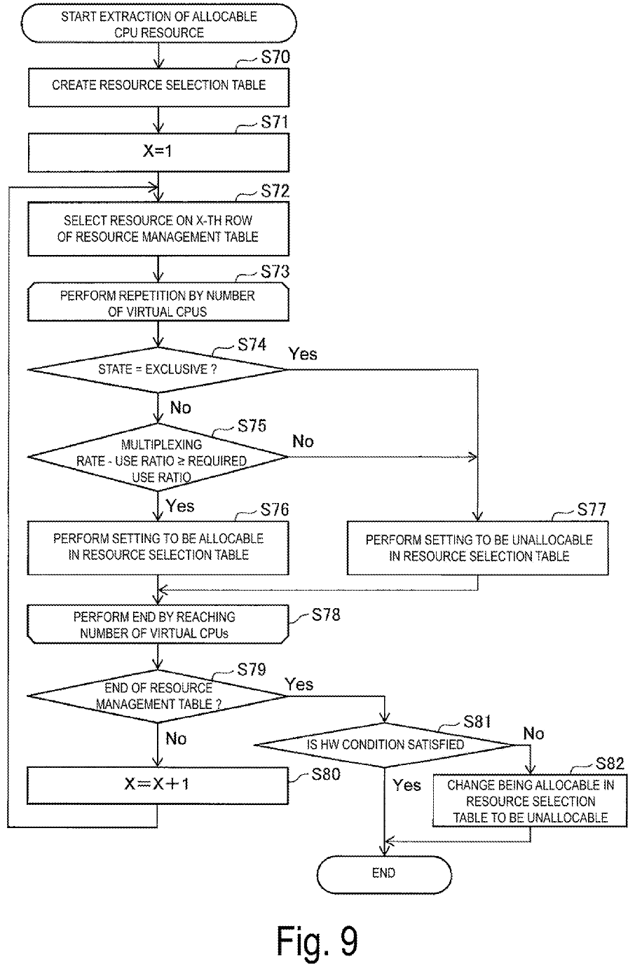

Then, the virtual resource management apparatus 3 extracts allocable physical CPU resources by the resource extraction unit 332 (Step S14), and selects a physical CPU resource (second physical CPU) to be allocated to the virtual machine by the resource selection unit 333 (Step S15). The processing of Steps S14 to S15 will be described in detail with reference to FIG. 9. The processing of steps S14 and S15 correspond to a procedure of selecting a second physical CPU that satisfies user requirements after the virtual machine is activated.

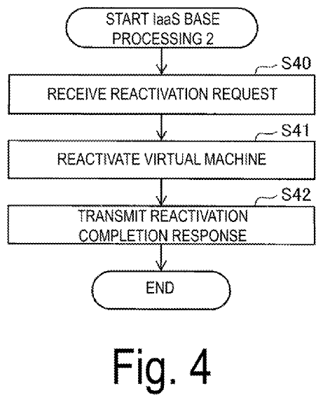

The resource management unit 331 updates the resource management table 339 shown in FIG. 5 (Step S16). The virtual machine setting file operation unit 334 updates the virtual machine setting file 53 (Step S17), and requests the IaaS base apparatus 4 to perform processing of reactivating the virtual machine (Step S18). Then, the IaaS base apparatus 4 performs second processing of reactivating the virtual machine (Step S19). The second processing will be described later with reference to FIG. 4. The processing of Steps S17 to S19 corresponds to a procedure of pinning the second physical CPU to each virtual CPU of the virtual machine. The resource assignment control unit 33 receives a resource assignment response from the IaaS base apparatus 4 (Step S20), and ends the processing in FIG. 2.

FIG. 3 is a flowchart illustrating the first processing performed by the IaaS base apparatus 4.

The IaaS base apparatus 4 receives resource request information from the virtual resource management apparatus 3 (Step S30).
The resource extraction unit 432 extracts allocable physical CPU resources from the resource information repository 435 (Step S31). The resource selection unit 433 selects a physical CPU resource to be allocated to the virtual machine from the extracted physical CPU resources (Step S32).

The resource management unit 431 updates the resource management table 439 based on the selection result (Step S33). The virtual machine control unit 436 activates the virtual machine (Step S34). The IaaS base apparatus 4 transmits a resource assignment response to the virtual resource management apparatus 3 (Step S35), and ends the processing in FIG. 3.

FIG. 4 is a flowchart illustrating the second processing performed by the IaaS base apparatus 4.

The IaaS base apparatus 4 receives a reactivation request from the virtual resource management apparatus 3 (Step S40). The virtual machine control unit 436 reactivates the virtual machine in response to the request (Step S41). The IaaS base apparatus 4 transmits a reactivation completion as a response to the virtual resource management apparatus 3 (Step S42) and ends the processing in FIG. 4.

FIG. 5 is a diagram illustrating the resource management table 339.

The resource management table 339 includes column HW Id, a hardware identifier, indicating each server 5 by an identifier, column CORE indicating each CPU core by a number, column MULTIPLEXING RATE, column USE RATIO, column STATE, and column ALLOCATION DESTINATION. Each row of the resource management table 339 corresponds to each CPU core.

MULTIPLEXING RATE indicates computing power of each CPU core based on the performance of the CPU core in a server 5. Here, a CPU core having an HW Id of #0 and a CORE number of 0 is selected as a standard.

USE RATIO indicates how much of the performance of the CPU core indicated by the MULTIPLEXING RATE is used.

The state indicates whether or not each CPU core is exclusively occupied by any virtual machine.

ALLOCATION DESTINATION indicates how each CPU core is allocated. “FOR ACTIVATION”, “HOST OS”, and virtual CPUs of each virtual machine are described in the allocation destination column. In the example of FIG. 5, one CPU core of each server 5 is selected as a CPU core dedicated for activation.

FIG. 6 is a diagram illustrating the resource selection table 337a for selecting an activation CPU.

The resource selection table 337a includes column FOR ACTIVATION in addition to column HW Id, a hardware identifier, indicating each server 5 by an identifier, column CORE indicating each CPU core by a number, column MULTIPLEXING RATE, column USE RATIO, column STATE, and column ALLOCATION DESTINATION. The resource selection table 337a is generated by the resource extraction unit 332.

The columns HW Id, CORE, MULTIPLEXING RATE, USE RATIO, and STATE are similar to the respective columns of the resource management table 339 in FIG. 5.

The column FOR ACTIVATION indicates whether or not the CPU core is allowed to be selected for activation.

FIG. 7 is a flowchart illustrating processing of selecting the activation CPU resource by the virtual resource management apparatus 3. The processing corresponds to the processing of Step S11 in FIG. 2 and corresponds to a procedure of selecting the first physical CPU to be allocated to activate a virtual machine in accordance with the use states of a plurality of physical CPUs included in the server.

The resource selection unit 333 creates the resource selection table 337 and writes values in the columns MULTIPLEXING RATE and USE RATIO (Step S50).

The resource selection unit 333 initializes a variable X to 1 (Step S51), and repeats the processing of Steps S52 to S57 for all CPU cores managed in the resource management table 339.

The resource selection unit 333 selects a resource on the X-th row of the resource management table 339 (Step S52).

If the state of the physical CPU resource is “EXCLUSIVE” (Yes) in Step S53, the resource selection unit 333 sets the physical CPU resource to be unallocable in the resource selection table 337 (Step S55).

If the state of the physical CPU resource is “NOT EXCLUSIVE” (No), the resource selection unit 333 sets the physical CPU resource to be allocable in the resource selection table 337 (Step S54). The NOT EXCLUSIVE includes both a case where no resource is allocated for the physical CPU resource and a case where the physical CPU resource is shared by a plurality of virtual machines.

If the resource selection unit 333 reaches the end of the resource management table 339 (Yes) in Step S56, the process proceeds to Step S58. If the resource selection unit 333 does not reach the end of the resource management table 339 (No), the resource selection unit 333 adds 1 to the variable X (Step S57), and returns to the processing of Step S52.

If the CPU core does not satisfy the hardware condition (No) in Step S58, the resource selection unit 333 sets the physical CPU resource to be unallocable in the resource selection table 337 (Step S59), and proceeds to processing of Step S60. If the CPU core satisfies the hardware condition (Yes), the resource selection unit 333 proceeds to processing in Step S60. The hardware condition refers to, for example, the anti-affinity attribute of OpenStack. The anti-affinity attribute designates that a specific virtual machines are required to be always performed by different physical servers.

In the resource selection table 337, the resource selection unit 333 calculates a value obtained by subtracting the use ratio from the multiplexing rate, and sorts the physical CPU resources in descending order by the obtained value (Step S60).

The resource selection unit 333 selects physical CPU resources corresponding a value obtained by multiplying the number of simultaneously active resources by constant α, from the sorted resource selection table 337 in order from the top of the resource selection table (Step S61). Note that α is a constant preset by the user.
The resource management unit 331 updates the resource management table 339 by writing “FOR ACTIVATION” in column ALLOCATION DESTINATION of the resource management table 339 (Step S62).
The resource assignment control unit 33 requests setting of the physical CPU resource of the IaaS base apparatus 4. The IaaS base apparatus 4 changes the physical CPU resource setting by changing the resource information repository 435 (Step S63), and ends the processing in FIG. 7. This makes the selected activation physical CPU resource to be viewable from the IaaS base apparatus 4.
As described above, the virtual resource management apparatus 3 selects the activation physical CPU resource of the virtual machine by observing the use state of the physical CPU resource when the virtual machine is activated. Thus, the virtual resource management apparatus 3 can stably activate the virtual machine.

FIG. 8 is a diagram illustrating the resource selection table 337b.

The resource selection table 337b includes column HW Id, a hardware identifier, indicating each server 5 by an identifier, and column CORE indicating each CPU core by a number. The resource selection table 337b further includes columns vCPU0, vCPU1, vCPU2, and vCPU3 in addition to columns MULTIPLEXING RATE, USE RATIO, STATE, and ALLOCATION DESTINATION. The resource selection table 337b is generated by the resource extraction unit 332.

The columns HW Id, CORE, MULTIPLEXING RATE, USE RATIO, STATE, and ALLOCATION DESTINATION are similar to the respective columns of the resource management table 339 in FIG. 5.

The column vCPU0 is a column indicating whether or not the CPU core has been selected as the virtual CPU #0. The column vCPU1 is a column indicating whether or not the CPU core has been selected as the virtual CPU #1. The column vCPU2 is a column indicating whether or not the CPU core has been selected as the virtual CPU #2. The column vCPU3 is a column indicating whether or not the CPU core has been selected as the virtual CPU #3.

FIG. 9 is a flowchart illustrating extraction processing of allocable resources and selection processing. The processing corresponds to the processing of Steps S14 to S15 in FIG. 2, and also corresponds to a procedure of extracting not-exclusive physical CPUs capable of performing a plurality of services, and selecting the second physical CPU from the extracted not-exclusive physical CPUs.

The resource extraction unit 332 creates the resource selection table 337b, and writes values in the columns MULTIPLEXING RATE and USE RATIO (Step S70).
The resource extraction unit 332 initializes the variable X to 1 (Step S71), and repeats the processing of Steps S72 to S80 for all the CPU cores managed in the resource management table 339.

The resource extraction unit 332 selects the resource on the X-th row of the resource management table 339 (Step S72). Then, processing of Step S73 to S78 are repeated by the number of virtual CPUs included in each virtual machine.

In Step S74, if the state of the physical CPU resource is not “EXCLUSIVE” (No), the resource selection unit 333 proceeds to processing in Step S75. If the state of the physical CPU resource is “EXCLUSIVE” (Yes), the resource selection unit 333 sets the physical CPU resource to be unallocable in the resource selection table 337b (Step S77), and proceeds to Step S78.
In Step S75, if the value obtained by subtracting the use ratio from the multiplexing rate of the physical CPU resource is equal to or greater than the required use ratio (threshold) (Yes), the resource selection unit 333 sets the physical CPU resource to be allocable in the resource selection table 337 (Step S76), and proceeds to Step S78. If the value obtained by subtracting the use ratio from the multiplexing rate is smaller than the required use ratio (No), the resource selection unit 333 sets the physical CPU resource to be unallocable in the resource selection table 337b (Step S77), and proceeds to Step S78.
If the processing has not been repeated by the number of virtual CPUs included in each virtual machine in Step S78, the resource selection unit 333 returns to Step S73 and repeats the processing.

In Step S79, if the resource selection unit 333 reaches the end of the resource management table 339 (Yes), the process proceeds to Step S81. If the resource selection unit 333 does not reach the end of the resource management table 339 (No), the resource selection unit 333 adds 1 to the variable X (Step S80), and returns to the processing of Step S72.

If the CPU core does not satisfy the hardware condition in Step S81 (No), the resource selection unit 333 sets the physical CPU resource to be unallocable in the resource selection table 337b (Step S82), and ends the processing in FIG. 9. If the CPU core satisfies the hardware condition (Yes), the resource selection unit 333 ends the processing in FIG. 9.

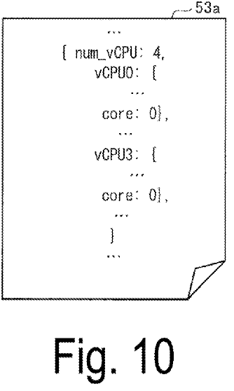

FIG. 10 is a diagram illustrating a virtual machine setting file 53a created by an IaaS base tool.

“Num_vCPU: 4,” indicates that the total number of virtual CPUs included in the virtual machine is four. “VCPU0: { . . . Core: 0},” indicates that the virtual CPU 0 is pinned to the physical CPU core 0. “VCPU3: { . . . Core: 0},” indicates that the virtual CPU 3 is pinned to the physical CPU core 0. As described above, the physical CPU core 0 is pinned to all the virtual CPUs 0 to 3 for activation.

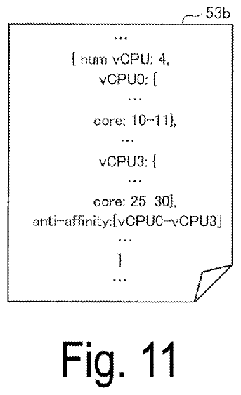

FIG. 11 is a diagram illustrating a virtual machine setting file 53b modified by the virtual resource management apparatus 3.

“Num_vCPU: 4,” indicates that the total number of virtual CPUs included in the virtual machine is four. “VCPU0: { . . . Core: 10-11},” indicates that the virtual CPU 0 is pinned to the tenth and eleventh physical CPU cores. “VCPU3: { . . . core: 25-30},” indicates that the virtual CPU 3 is pinned to the 25th and 30th physical CPU cores. As described above, the virtual resource management apparatus 3 allocates the physical CPU to each virtual CPU in accordance with a user request.

“Anti-affinity: [vCPU0-vCPU3]” indicates that an anti-affinity attribute is allocated to the virtual CPU 0 to the virtual CPU 3.

As described above, the present embodiment can increase utilization efficiency of virtual machine resources while operating and managing the virtual machine using the IaaS base.

Effect of Embodiment

Regarding the physical CPU resource, the activation core is separated from other CPU cores, and the IaaS base apparatus 4 activates the virtual machine using the activation core. Then, the virtual resource management apparatus 3 rewrites the setting file of the virtual machine to an allocation condition that satisfies the user requirement, and applies the setting. This enables an allocation policy of the CPU core for each virtual CPU to be set, which increase the utilization efficiency of the virtual machine resources while operating and managing the virtual machine using the IaaS base.

In addition, it is possible to flexibly select the activation resources before the virtual machine is activated, in accordance with the use state of the resource or the simultaneous activation of the virtual machines. Thus, in particular, it is possible to localize the influence and to increase the efficiency in a system in which multiple virtual machines are simultaneously activated.

### Modification Example

The present disclosure is not limited to the above embodiment, and can be modified and implemented without departing from the gist of the present disclosure. For example, the modifications are following (a) to (c).
(a) The hardware conditions in the processing of Step S58 in FIG. 7 and the processing of Step S81 in FIG. 9 are not limited to the anti-affinity attribute, and may be conditions based on any attribute.
(b) In the processing of Step S15 in FIG. 2, the selection criterion of the physical CPU resource to be allocated to the virtual machine is not limited to the above embodiment, and may be any criterion satisfying the user requirement.
(c) The number of physical CPU cores which are allocated to the virtual CPU of the virtual machine and activates the virtual machine is not limited to one, and may be plural. The physical CPU core that activates the virtual machine may be the same physical CPU core for another service having a low performance requirement.

### REFERENCE SIGNS LIST

1 Virtual resource management system
2 Client terminal
3 Virtual resource management apparatus
31 User interface
32 Resource requesting unit
33 Resource assignment control unit
331 Resource management unit
332 Resource extraction unit
333 Resource selection unit
334 Virtual machine setting file operation unit
335 Resource information repository
337, 337a, 337b Resource selection table
339 Resource management table
4 IaaS base apparatus
42 Resource requesting unit
43 Resource assignment control unit
431 Resource management unit
432 Resource extraction unit
433 Resource selection unit
435 Resource information repository
436 Virtual machine control unit
437 Virtual machine image repository
439 Resource management table
5 Server
51 Activation CPU
52 Service CPU
53 Virtual machine setting file

1. A non-transitory computer readable medium storing a virtual resource allocation program including instructions that cause computers to perform operations comprising:
allocating a first physical central processing unit (CPU) to a virtual CPU of a virtual machine implemented on a server, by an Infrastructure as a Service (IaaS) base, and activating the virtual machine;
selecting a second physical CPU satisfying a user requirement after the virtual machine is activated; and
pinning the second physical CPU to each virtual CPU of the virtual machine.

2. The virtual resource allocation program according to claim 1 causing the computer to further perform the operations comprising:
selecting the first physical CPU to be allocated in order to activate the virtual machine, in accordance with use states of a plurality of physical CPUs in the server.

3. The virtual resource allocation program according to claim 2 causing the computer to further perform the operations comprising:
setting a physical CPU that does not perform a service and a physical CPU that simultaneously performs a plurality of services as selection targets of the first physical CPU; and
excluding an exclusive physical CPU that performs a specific service from the selection target of the first physical CPU.

4. The virtual resource allocation program according to claim 1 causing the computer to further perform the operations comprising:
extracting physical CPUs which are not exclusive and are capable of performing a plurality of services; and
selecting the second physical CPU from the extracted physical CPUs which are not exclusive.

5. A virtual resource allocation method comprising:
allocating a first physical central processing unit (CPU) to a virtual CPU of a virtual machine implemented on a server, by an Infrastructure as a Service (IaaS) base, and activating the virtual machine;
selecting a second physical CPU satisfying a user requirement after the virtual machine is activated; and
pinning the second physical CPU to each virtual CPU of the virtual machine.

6. A virtual resource management apparatus comprising:
a resource selection unit configured to:
select a first physical central processing unit (CPU) to be allocated as a virtual CPU of a virtual machine by an Infrastructure as a Service (IaaS) base, for an initial activation of the virtual machine implemented on a server, and
select a second physical CPU satisfying a user requirement after the virtual machine is activated; and
a virtual machine setting file operation unit configured to pin the second physical CPU to each virtual CPU of the virtual machine.

7. The virtual resource management apparatus according to claim 6, further comprising:
a resource extraction unit configured to extract a physical CPU which is capable of performing a plurality of services and is not exclusive, as a candidate for the first physical CPU.

8. The virtual resource management apparatus according to claim 7,
wherein the resource extraction unit excludes an exclusive physical CPU that performs a specific service from a selection target of the first physical CPU.
